(19) United States
(12) Patent Application Publication
(10) Pub. No.: US 2011/0202368 A1
(43) Pub. Date: Aug. 18, 2011

(54) EMAILING/TEXTING BIOMETRIC DATA FOR AUTOMATIC EMR INCORPORATION

(75) Inventors: Christopher J. Stakutis, Concord, MA (US); Mark Hessler, Holliston, MA (US)

(73) Assignee: COMPUTER ASSOCIATES THINK, INC., Islandia, NY (US)

(21) Appl. No.: 12/707,908

(22) Filed: Feb. 18, 2010

(51) Int. Cl. G06Q 10/00; G06Q 50/00; G06F 17/30; G06F 15/16

(52) U.S. Cl. 705/3; 709/206; 707/755; 709/219; 707/E17.01; 707/E17.058

(57) ABSTRACT

A message from a device may be automatically identified by an identifier associated with the message or the device or combination thereof. The identifier may be mapped to a user record in a database. The message may be parsed into health related data associated with the user. The health related data is automatically stored into the user record of the database.

### FIELD

The present disclosure relates generally to computer system and software, and more particularly to emailing/texting biometric data for automatic electronic medical record (EMR) incorporation.

### BACKGROUND

The majority of the world-spending on healthcare may be attributed to the care and treatment of patients with the common chronic conditions, for example, type-II diabetes, hypertension, and others. Most of that spending could be avoided if better care or preventive actions were to be taken. Such actions or care may include having better control of body or medical factors such as weight, blood pressure, medication usage, and others. New wireless biometric devices now exist that are affordable and work with modern computers. Acquiring base biometrics regularly can help a clinician better manage a patient and similarly help the patients pay more attention to their own health.

However, there are some drawbacks to using those wireless or in-home devices. For example, they are not quite affordable enough for the patients. They also can be cumbersome to integrate with a computer system. Further, the patient may not have those devices with him or her, when there is a need or desire to report a measurement. In addition, some health-related data simply cannot be detected by available devices. Such data may include calorie intake, exercise data, and others. Therefore, there is a need for more convenient methods of reporting health related data.

### BRIEF SUMMARY OF THE INVENTION

A method and system for automatic EMR incorporation of biometric data are presented. The method, in one aspect, may include receiving a message from a device and automatically identifying the message by an identifier associated with the message or the device or combination thereof. The method may also include mapping the identifier to a user record in a database and parsing the message into health related data associated with the user. The method may further include storing the health related data into the user record of the database.

A system for automatic EMR incorporation of biometric data, in one aspect, may include a storage device and a processor operable to receive a message from a device. The processor may be further operable to automatically identify the message by an identifier associated with the message or the device or combination thereof, and to map the identifier to a user record in a database. The processor may be also operable to parse the message into health related data associated with the user, and to store the health related data into the user record of the database on the storage device.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an architectural diagram illustrating components for system of the present disclosure in one embodiment.

FIG. 2 is a flow diagram illustrating a method in one embodiment for emailing/texting biometric data for automatic EMR incorporation.

### DETAILED DESCRIPTION

The system and method of the present disclosure may utilize ordinary cell phones, personal digital assistants (PDAs), or computer systems to achieve automatic electronic medical record (EMR) incorporation. A patient is enabled to “text” (or use electronic mail (email), short message service (SMS), or others) a biometric information which may be cryptic. A system such as a backend system or server system or another that receives the information decomposes and updates the appropriate parameters in the patient's EMR. The system may automatically identify the patient by the device address or identifier of the patient's device that was used to submit the data. Thus, there is no need for patients to go through the steps of logging in or specifying any ancillary information before submitting their biometric data.

The patient may send short natural language messages, and the receiving system automatically parses and records the relevant information. The message may include one or more lines and may include one or more measurements. For instance, the message may include several lines each line used to submit a different measurement. The message also may be a single line, and even may be in the subject line of an email or the like. Thus, the message may be in the body of the email or the message may be part of a header, metadata or other parts of an email. The following illustrate some examples of a message:
220 pounds,
220 lbs.,
123 kg.
8 pain,
20 minutes (exercise),
lite lunch,
heavy dinner,
120/80,
120 80,
and so on.

Such short or cryptic messages may be used without, for example, the complexity of accessing a full computer system or running an application or logging into a web site and navigating through web pages. Therefore, the patient may need only seconds of the patient's time to submit his or her health or biometric or like information.

The simplicity and speed to enter personal biometric or health related data into a health management system or the like of the present disclosure may encourage the patients who would normally be deterred from submitting such data. There is no need to log-on as the patient is identified by their send-from address, cellular telephone number, email address or others, and referenced in their patient information record. The patient can be anywhere and use an ordinary device or equipment such as the cellular phone, PDA or email system.

One of the main challenges in any health/wellness solution is the acquisition of data about the patient. Patients are often reluctant to visit web sites on a regular basis and enter data. And some of the data such as exercise and caloric intake are difficult to obtain automatically or even with device-assisted automation, as such data are typically manually or hand-entered by the patient. The system that receives and records the data may also send out reminders, e.g., “We need a recent weight measurement, please reply”, and field the response. This may greatly increases compliance because it would not be complex for the patient to simply “reply” with data using the equipments or devices the patient is used to or familiar with.

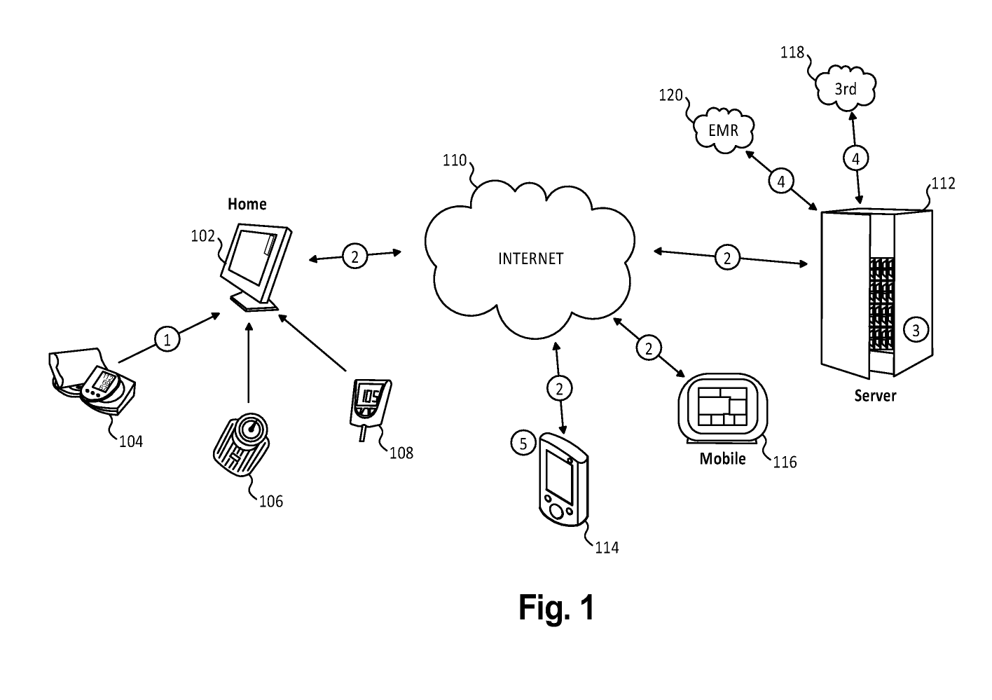

FIG. 1 is an architectural diagram illustrating components for system of the present disclosure in one embodiment. Health or wellness information and/or related data may be communicated to a computer system 112, for example, a server system that receives and keeps records of patient data. The computer system 112 may be a part of a health management system, but need not be. The computer system 112 may include one or more processors, memory devices, network card, and other hardware components. The computer system 122 may include components to serve as one or more web servers, data rendering components, data analysis components, and a rules engine, for instance, running on top of an integrator-supplied SQL database. The integrator controls physical security and may have additional software security, e.g., encryption and the like.

A “Home” environment may include a device aggregator “hub” 102 and various short-range wireless Food and Drug Administration (FDA) biometric devices 106, 108. Communication from home-based devices 104, 106, 108 to home “hub” 102 may use Bluetooth™ or other standard technology (typically wireless but need not be) with protocol stacks that have error detection/correction and retries.

The home “hub” 102 may be a computer system such as a personal computer, a laptop or another computer system or device, that for example, may include one or more processors and/or cores, one or more memory devices, wired and/or wireless network cards and associated device drivers. The processor or the like of the home “hub” 102 is capable of executing instructions, for example, loaded from the memory device to perform the methods described herein. For instance, the home “hub” receives data communicated from the home-based devices 104, 106, 108. The home-base devices may include, but is not limited to, equipments that measure weight of a person, heart pressure, glucose level, pulse, etc. If the protocol layer presented includes any data integrity check (e.g., checksum) the home “hub” 102 may verify or discard the data. Unique device identifiers (IDs) are carried with the data and stored in the database (e.g., in 102) to fully identify the source of the data. The unique ID transmitted with the source may be the identifiers of the individual devices 104, 106, 108 connected to the home “hub” and/or the identifier of the home “hub” 102. In one aspect, unique IDs may be given or assigned to each device, and/or an address such as IP address, email address, and other unique identifiers already used for the devices or users may be utilized.

The home “hub” 102, other mobile devices 114, 116, and/or other intelligent devices including, but not limited to computers, phones, Internet display devices, vehicles, may communicate with the server system 112 using light weight SOA (XML)—service oriented architecture (extensible markup language)—carried via hypertext transfer protocol secure (HTTPS), for instance, via communication networks such as the Internet 110. The XML language used in the present disclosure need not carry additional error detection/correction; for example, it may be assumed that the various underlying transports perform as specified. Components such as software components, e.g., Java™ or Flash™, for communicating with the server system 112 may be loaded onto these intelligent devices.

The server system 112 may also include interfaces to pull and/or push data to various 3^{rd} party systems (medical records or other repositories of data) 118, 120 using whatever protocol the vendor specifies; typically SOA XML via HTTPS.

A user/patient can at any time send a short natural language message to the server system 112 (via text or email) that has a biometric value (e.g. 212 pounds, 120/80, 20 min. (minutes) exercise). The server system 112 automatically updates the user/patient's record based on the “from” address.

The server system 112 may also include a processing unit or module or an algorithm that checks, for example, periodically on a predetermined basis, whether and what types of data has been received from the user for whom the server system 112 is keeping a record or maintaining a health or wellness program. Upon determining that the user has not sent in the data, the server system 112 may issue a notice or prompt the user by messaging the user to one or more devices which the user is using to email or text (or others) the data. The prompt may include what type of data the user should send, e.g., “need recent fitness activity or exercise information.”

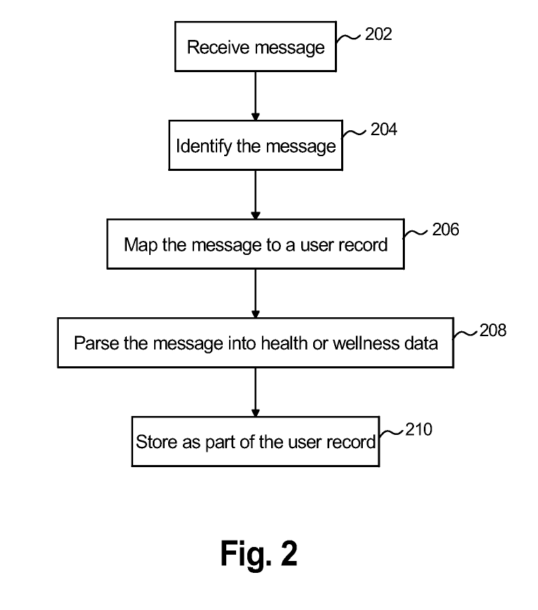

FIG. 2 is a flow diagram illustrating a method in one embodiment for emailing/texting biometric data for automatic EMR incorporation. At 202, the server system receives a message from one or more of the intelligent devices. For example, as described above, the devices may be devices such as a computer, mobile phone, smart phone, personal digital assistant, a vehicle, or others, or any combinations thereof. At 204, the server system automatically identifies the message, for example, by the address of the device that sent the message, or example, if the message is an email message, by the “from” field of the message. The server system uses the identifier to map the index into a user record, for instance, stored in a database at 206. The database, for example, may store medical or health information of the users. At 208, the server system parses the message. For example, the message may be in a cryptic form or natural language form. The text message in such form may be parsed using a parser to extract or retrieve data associated with that user's health or wellness. At 210, the data is stored into the user's record in the database.

The various functionalities and modules of the systems and methods of the present disclosure may be implemented or carried out distributedly on different processing systems or on any single platform, for instance, accessing data stored locally or distributedly on the network.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for automatic EMR incorporation of biometric data, comprising:
receiving a message from a device;
automatically identifying the message by an identifier associated with the message or the device or combination thereof;
mapping the identifier to a user record in a database;
parsing the message into health related data associated with the user; and
storing the health related data into the user record of the database,
the steps of identifying, mapping, parsing and storing performed using a processor.

2. The method of claim 1, wherein the device includes one or more of a computer, mobile telephone, smart phone, personal digital assistant, a vehicle, or combinations thereof.

3. The method of claim 1, wherein the message includes one or more of email message, SMS message, or text message, or combinations thereof.

4. The method of claim 1, wherein the identifier associated with the message is a “from” address of the message.

5. The method of claim 1, wherein the identifier associated with the message is an address of the device.

6. The method of claim 1, wherein the devices are remotely located from the processor.

7. The method of claim 1, wherein the processor pulls and pushes the stored user records to a remote server managing electronic medical record of the user.

8. A system for automatic EMR incorporation of biometric data, comprising:
a storage device;
a processor operable to receive a message from a device and automatically identify the message by an identifier associated with the message or the device or combination thereof, the processor further operable to map the identifier to a user record in a database and parse the message into health related data associated with the user, the processor further operable to store the health related data into the user record of the database on the storage device.

9. The system of claim 8, wherein the device includes one or more of a computer, mobile telephone, smart phone, personal digital assistant, a vehicle, or combinations thereof.

10. The system of claim 8, wherein the message includes one or more of email message, SMS message, or text message, or combinations thereof.

11. The system of claim 8, wherein the identifier associated with the message is a “from” address of the message.

12. The system of claim 8, wherein the identifier associated with the message is an address of the device.

13. The system of claim 8, wherein the devices are remotely located from the processor.

14. The system of claim 8, wherein the processor is further operable to pull and push the stored user records to a remote server managing electronic medical record of the user.

15. A computer readable storage medium storing a program of instructions executable by a machine to perform a method of automatic EMR incorporation of biometric data, comprising:
receiving a message from a device;
automatically identifying the message by an identifier associated with the message or the device or combination thereof;
mapping the identifier to a user record in a database;
parsing the message into health related data associated with the user; and
storing the health related data into the user record of the database,

16. The computer readable storage medium of claim 15, wherein the device includes one or more of a computer, mobile telephone, smart phone, personal digital assistant, a vehicle, or combinations thereof.

17. The computer readable storage medium of claim 15, wherein the message includes one or more of email message, SMS message, or text message, or combinations thereof.

18. The computer readable storage medium of claim 15, wherein the identifier associated with the message is a “from” address of the message.

19. The computer readable storage medium of claim 15, wherein the identifier associated with the message is an address of the device.

20. The computer readable storage medium of claim 15, further including:
prompting the user to send the message via the device.
